(19) United States
(12) Patent Application Publication
(10) Pub. No.: US 2024/0276399 A1
(43) Pub. Date: Aug. 15, 2024

(54) ADAPTIVE DIMENSIONING AND PROVISIONING OF TELECOMMUNICATIONS NETWORK CLOUD-BASED INFRASTRUCTURE

(71) Applicant: Telefonaktiebolaget LM Ericsson (publ), Stockholm (SE)

(72) Inventors: Shrihari VASUDEVAN, Chennai, Tamil Nadu (IN); M J PRASATH, Chennai (IN)

(21) Appl. No.: 18/567,239

(22) PCT Filed: Jun. 9, 2021
(86) PCT No.: PCT/IN2021/050559

§ 371 Date: Dec. 5, 2023

(51) Int. Cl. H04W 52/36; H04W 24/02

(52) U.S. Cl. CPC H04W 52/367; H04W 24/02

(57) ABSTRACT

A method performed by a network node for adaptive dimensioning and provisioning a resource of current resources of a cloud-based infrastructure of a telecommunications network is provided. The method includes dimensioning bounds of usage of the resource for a dimensioning interval that is greater than a scaling interval of an underlying orchestrator based on an amount of data available. The method further includes provisioning of the resource when a maximum bound of the dimensioning exceeds the current resources; checking whether measurement of actual usage of the resource deviates from at least one of the bounds by more than a deviation threshold value; performing a change to the value of the deviation threshold based on the checking.

### TECHNICAL FIELD

The present disclosure relates generally to adaptive dimensioning and

provisioning at least one resource of a cloud-based infrastructure of a telecommunications network, and related methods and apparatuses.

### BACKGROUND

Dimensioning of telecommunications cloud infrastructure (e.g., virtual network function (“VNF”), computing processing unit (“CPU”), or memory (“MEM”)) may be critical for pre-sales support (e.g., contract formulation), green and brown field deployment, and/or as an ongoing activity to cater to the increase in subscriber growth and introduction of new services, with technology evolution. Introduction of network function virtualization (“NFV”) enabled the expansion of network capacity in a shorter period of time. Operators may have deployed their VNFs in a NFV architecture predominantly using on-premises telecommunications cloud infrastructure. A NFV architecture may enable an operator to scale down and scale up faster than the traditional physical network function (“PNF”) networks, where the hardware is procured, commissioned and connected in order to be made available for network application deployment.

### SUMMARY

In various embodiments, a method is provided that is performed by a network node for adaptive dimensioning and provisioning at least one resource of a cloud-based infrastructure of a telecommunications network, the method being orchestrator and cloud infrastructure agnostic. The method includes dimensioning, to obtain a forecast of, a minimum bound of usage of the at least one resource and a maximum bound of usage of the at least one resource for a dimensioning interval based on an amount of data available. The dimensioning interval is greater than a scaling interval of an underlying orchestrator. The method further includes provisioning of the at least one resource when the maximum bound of the dimensioning forecast exceeds current resources of the cloud-based infrastructure. The method further includes checking, on a periodic basis defined by the scaling interval of the underlying orchestrator, whether a measurement of actual usage of the at least one resource deviates from at least one of the minimum bound or the maximum bound by more than a deviation threshold value. The method further includes performing a change to the value of the deviation threshold to a new value based on the checking.

In some embodiments, the change to the value is a decrease when the checking results in a deviation from at least one of the minimum bound or the maximum bound by more than the deviation threshold value, and the method further includes performing a re-dimensioning and a re-provisioning of the at least one resource for a further dimensioning interval.

In some embodiments, the change to the value is an increase when the checking results in no deviation and the value of the deviation threshold is less than a pre-defined maximum bound.

In some embodiments, the change to the value is zero when the checking results in no deviation and the value of the deviation threshold equals a pre-defined maximum bound, and the method further includes performing a re-dimensioning and a re-provisioning of the at least one resource for a further dimensioning interval when a time-duration of the dimensioning interval lapses without the occurrence of a deviation.

In some embodiments, the performing the re-dimensioning and the re-provisioning re-uses the dimensioning and the provisioning of the previous dimensioning interval.

In some embodiments, the method further includes controlling a frequency of the re-dimensioning and re-provisioning of the at least one resource for the further dimensioning interval based on the change to the value of the deviation threshold value.

In various embodiments, a network node is provided. The network node includes processing circuitry, and memory coupled with the processing circuitry. The memory includes instructions that when executed by the processing circuitry causes the network node to perform operations. The operations include dimension, to obtain a forecast of, a minimum bound of usage of the at least one resource and a maximum bound of usage of the at least one resource for a dimensioning interval based on an amount of data available. The dimensioning interval is greater than a scaling interval of an underlying orchestrator. The operations further include provisioning of the at least one resource when the maximum bound of the dimensioning forecast exceeds current resources. The operations further include check, on a periodic basis defined by the scaling interval of the underlying orchestrator, whether a measurement of actual usage of the at least one resource deviates from at least one of the minimum bound or the maximum bound by more than the deviation threshold value. The operations further include perform a change to the value of the deviation threshold to a new value based on the check.

In various embodiments, a network node in a first network is provided that is adapted to perform operations. The operations includes dimension, to obtain a forecast of, a minimum bound of usage of the at least one resource and a maximum bound of usage of the at least one resource for a dimensioning interval based on an amount of data available. The dimensioning interval is greater than a scaling interval of an underlying orchestrator. The operations further include provisioning of the at least one resource when the maximum bound of the dimensioning forecast exceeds current resources of the cloud-based infrastructure. The operations further include check, on a periodic basis defined by the scaling interval of the orchestrator, whether a measurement of actual usage of the at least one resource deviates from at least one of the minimum bound or the maximum bound by more than the deviation threshold value. The operations further include perform a change to the value of the deviation threshold to a new value based on the check.

In various embodiments, a computer program including program code to be executed by processing circuitry of a network node is provided. The program code causes the network node to perform operations. The operations includes dimension, to obtain a forecast of a minimum bound of usage of the at least one resource and a maximum bound of usage of the at least one resource for a dimensioning interval based on an amount of data available. The dimensioning interval is greater than a scaling interval of an underlying orchestrator. The operations further include provisioning of the at least one resource when the maximum bound of the dimensioning forecast exceeds current resources of the cloud-based infrastructure. The operations further include check, on a periodic basis defined by the scaling interval of the underlying orchestrator, whether a measurement of actual usage of the at least one resource deviates from at least one of the minimum bound or the maximum bound by more than the deviation threshold value. The operations further include perform a change to the value of the deviation threshold to a new value based on the check.

In various embodiments, a computer program product including a non-transitory storage medium including program code to be executed by processing circuitry of a network node is provided. Execution of the program code causes the network node to perform operations. The operations include dimension, to obtain a forecast of, a minimum bound of usage of the at least one resource and a maximum bound of usage of the at least one resource for a dimensioning interval based on an amount of data available. The dimensioning interval is greater than a scaling interval of an underlying orchestrator. The operations further include provisioning of the at least one resource when the maximum bound of the dimensioning forecast exceeds current resources of the cloud-based infrastructure. The operations further include check, on a periodic basis defined by the scaling interval of the underlying orchestrator, whether a measurement of actual usage of the at least one resource deviates from at least one of the minimum bound or the maximum bound by more than the deviation threshold value. The operations further include perform a change to the value of the deviation threshold to a new value based on the check.

Data-driven dimensioning solutions catering to different data-availability scenarios and adaptive dimensioning-driven provisioning remain unsolved. In various embodiments of the present disclosure, a method is provided that dynamically identifies the need and controls the frequency for re-dimensioning and/or followed by re-provisioning of telecommunications resources (e.g., VNFs such as Multimedia Telephony

Application Server (MTAS), Call Session Control Function (CSCF), Secure Border Gateway (SBG), etc.) by continuous measurement of deviation between the actual resources used and the dimensioning requirement-forecast bounds. The method involves using adaptive dimensioning to enable auto-scaling by pre-provisioning resources for a duration greater than a scaling interval of the auto-scaler. Potential advantages of the dimensioning may include that by using machine learning in the method, not only may the process be automated with results provided immediately (after prior training), but also the dimensioning may cater to different data-availability scenarios. The adaptive dimensioning-driven provisioning also is proactive on a longer time-scale (that is, a dimensioning interval), and can be reactive (or proactive) on a short time-scale (that is, a scaling interval) as per an underlying orchestrator, through adaptive dimensioning. Additionally, the auto-scaler of the underlying orchestrator may respond very rapidly to changes in network traffic by attaching or detaching provisioned resources into and out of service. Thus, an additional advantage may be fast deployment of resources, and may include low latency and with a level of fault tolerance. Further, the method may avoid synchronization issues between an underlying cloud infrastructure provider and orchestrator; and may help provide service (e.g., QoS) guarantees that may enable differential pricing for operators.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a telecommunication network in accordance with some embodiments of the present disclosure;

FIG. 2 is flow chart of operations of an example embodiment according to some embodiments of the present disclosure;

FIG. 3 is a flow chart of operations of an example embodiments for dimensioning for a minimal data scenario according to some embodiments of the present disclosure;

FIG. 4 is a flow chart of operations of an example embodiment for dimensioning for a sufficient data scenario according to some embodiments of the present disclosure;

FIG. 5 is a flow chart of operations in a system for adaptive dimensioning-driven provisioning of resources for a telecommunications cloud infrastructure according to some embodiments of the present disclosure;

FIG. 6 is a block diagram of elements, and flow of operations, for training a dimensioning frequency controller in accordance with some embodiments of the present disclosure;

FIG. 7 is a block diagram illustrating elements of a network node configured to perform operations and provide communication according to embodiments of the present disclosure;

FIG. 8 is a block diagram of a virtualization environment in accordance with some embodiments; and

FIGS. 9 and 10 are flow chart illustrating operations of a network node in accordance with some embodiments of the present disclosure.

### DETAILED DESCRIPTION

The present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. The term “network node” is used in a non-limiting manner and, as explained below, can refer without limitation to any type of network node in a telecommunications network (e.g., including a virtual network node and/or virtual elements or functions) for dimensioning and provisioning at least one resource of a cloud-based infrastructure of a telecommunications network. The method is orchestrator (e.g., an element(s) providing management in a virtualization environment as described further herein) and cloud infrastructure agnostic by removing coordination issues in multi-layer application infrastructure as described further herein.

The following explanation of potential problems with some approaches is a present realization as part of the present disclosure and is not to be construed as previously known by others.

Although NFV may have improved the expansion and scalability of telecommunications networks compared to traditional PNF networks, the underlying infrastructure usage is not optimized. Real time scaling up and down remains an unsolved problem. In some approaches, efforts are taken to try to understand the dimensioning requirement based on historical data from performance management (“PM”) counters tracking network performance and/or network behavior and other factors including, e.g., a service type, a number of subscribers, etc.

In some approaches, it can take days or weeks to produce a dimensioning estimate with currently available tools. Additionally, telecommunications dimensioning tools are primarily siloed applications, with their usage and modification including cumbersome manual intervention. Dimensioning with minimal data (e.g., no network traffic data) also is a challenge.

In some approaches, auto-scaling solutions are static, reactive and are based on threshold values applied to CPU and/or memory utilization. Such approaches do not effectively handle spikes in network traffic.

Further, in some approaches towards auto-scaling driven by resource forecasting, the approaches do not consider potential latency and/or quality of service (“QoS”) issues resulting from synchronization issues in multi-layer application infrastructure. Such approaches do not enable communication service providers (“CSPs”) to provide service-level guarantees to customers willing to pay for it.

Some approaches for auto-scaling directly optimize the resources required and do not attempt to optimize the frequency of dimensioning, based on network traffic.

With the introduction of Fifth Generation (“5G”) mobile technology and the future sixth generation (“6G”) mobile technology, and a push towards Zero-Touch operation, it is important that a dimensioning and auto scaling approach also be Zero-Touch with optimized infrastructure usage.

Data-driven dimensioning solutions catering to different data-availability scenarios and adaptive dimensioning-driven autoscaling remain unsolved.

Various embodiments of the present disclosure may provide solutions to these and other potential problems. In various embodiments of the present disclosure, a method is provided that dynamically identifies the need and controls the frequency for re-dimensioning and re-provisioning or followed by re-provisioning of telecommunications applications (e.g., VNFs) by periodic (e.g., defined by a scaling interval of an auto-scaler of the underlying orchestrator) measurement of deviation between the actual resources used and dimensioning requirement-forecast bounds. The method also involves using this adaptive dimensioning to enable auto-scaling by pre-provisioning resources for a duration greater than a scaling interval of the auto-scaler of the underlying orchestrator (e.g., a standard scaling interval). This adaptive dimensioning and proactive provisioning of resources may circumvent synchronisation issues in multilayer application infrastructure and enable CSPs to provide QoS guarantees and, thus, can be orchestrator and cloud infrastructure agnostic. For example, provisioning of resources takes time. When multi-layer application infrastructure are involved, synchronization issues can become an additional issue, and can be a major challenge in reactive systems. Adaptive dimensioning for a dimensioning interval that is larger than the scaling interval (e.g., much larger) and pre-provisioning resources for the duration of the dimensioning interval addresses synchronisation issues by provisioning resources proactively based on the longer dimensioning interval. As a consequence, even if provisioned resources take time, provisioning may only be needed after some scaling intervals (e.g., as opposed to after each scaling interval). As used here, the term “scaling interval(s)” is interchangeable and may be replaced with the terms “time-step(s)” or “measurement(s)”.

In various embodiments, flexible dimensioning is performed using different regression and/or forecasting models (e.g., artificial intelligence (“AI”) and/or machine learning (“ML”) models) for different data-availability scenarios, as described further below. Additionally, publicly available data-sources may be used or leveraged.

In various embodiments, adaptive dimensioning-driven autoscaling is performed by: (a) dimensioning (also referred to herein as forecasting) and provisioning (or de-provisioning, as required) resources adaptively, in response to changing network traffic; and (b) dimensioning for a period greater than (e.g., much greater than) the scaling interval of an underlying auto-scaler/dimensioning may allow an underlying auto-scaler to pro-actively, or even reactively, respond (e.g., a very quick response) to resource needs. In an example embodiment, the scaling interval is a time period in a range of five (5) minutes to fifteen (15) minutes and the dimensioning interval is a time period in a range of one (1) hour to twelve (12) hours (or more, e.g., twenty-four (24) hours).

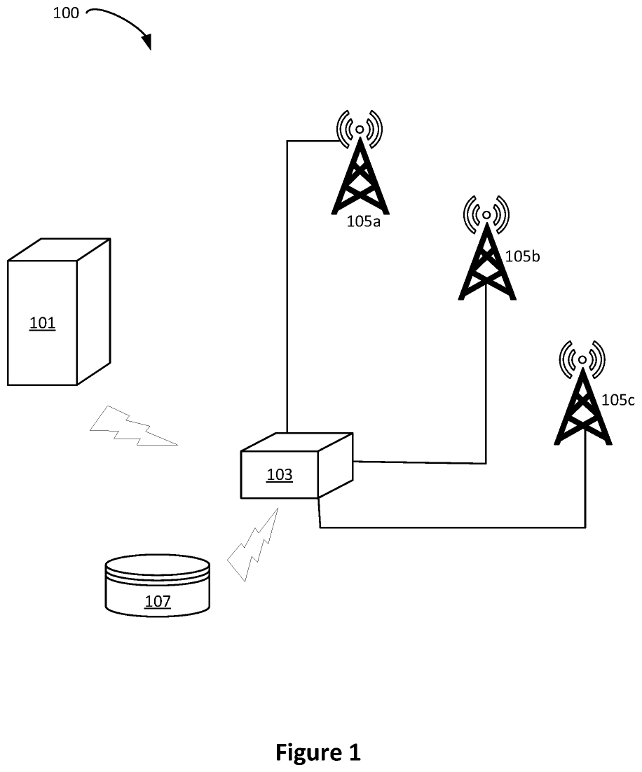

FIG. 1 is a schematic diagram illustrating an example of a telecommunication network in accordance with some embodiments of the present disclosure. Telecommunications network 100 includes a radio access network node 103, including radio towers 105a, 105b, 105c, and network node 101 and database 107. Radio access network node 103 (or any other similar 3rd Generation Partnership Project (3GPP) access node or non-3GPP access point), facilitates direct or indirect connection of user equipment (UE), such as by connecting UEs to the core network over one or more wireless connections. Elements of telecommunications network 100 may include cloud based infrastructure (e.g., network node 101, database 107, and elements of a core network (not illustrated in FIG. 1).

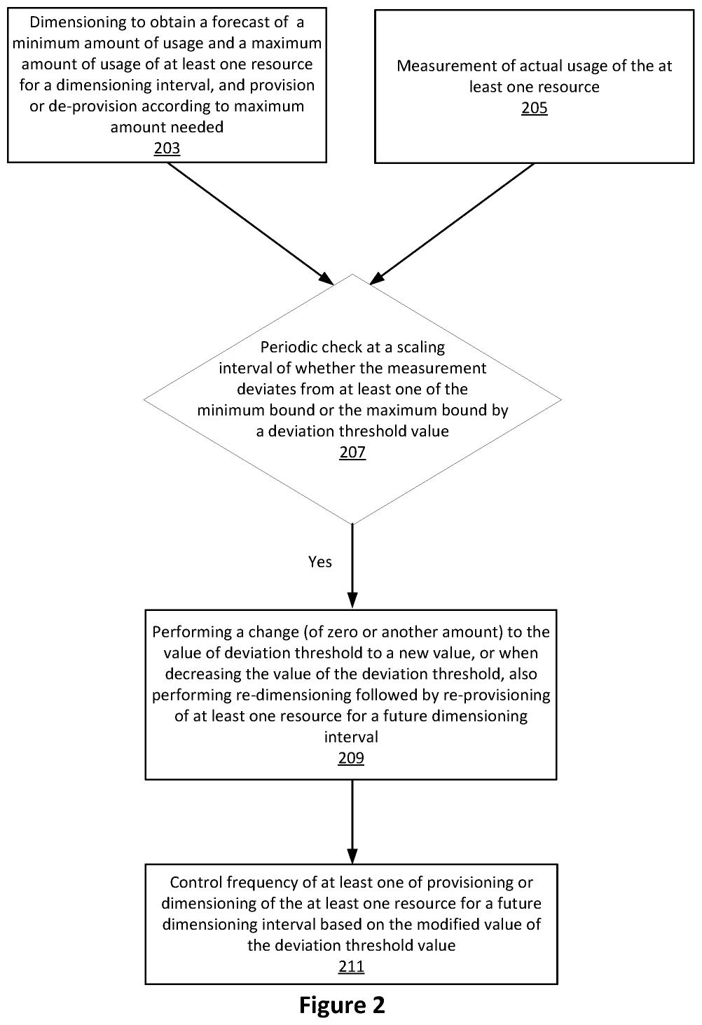

FIG. 2 is flow chart of operations of an example embodiment according to some embodiments of the present disclosure.

Referring to FIG. 2, an example embodiment of the method for adaptive dimensioning-driven auto-scaling is as follows. This example embodiment uses arbitrary numbers/values that may be specified or learnt from data (e.g., using approaches described herein), and the method of the present disclosure is not limited to such numbers/values. The example embodiment starts with a maximum deviation threshold value, e.g., 10%. The method includes operation 203 performing dimensioning to obtain a forecast for a dimensioning interval (e.g., one hour ahead) that identifies minimum and/or maximum resources needed and provisioning or de-provisioning according to the maximum resources needed. For a scaling interval (e.g., a scaling interval of every five minutes of an underlying orchestrator with auto-scaling capability), the method includes operation 207 periodically checking a deviation of the actual usage of the resources 205 compared to the forecast (e.g., max(actual -forecast maximum, forecast minimum-actual, 0)). Meanwhile, the auto-scaler of an underlying orchestrator with auto-scaling capability can keep attaching or detaching (provisioned) VNFs into service, as needed (not shown in FIG. 2). The attaching or detaching can happen proactively (e.g., one scaling interval ahead) or possibly, even reactively.

In the example embodiment, when there is a frequent deviation (e.g., greater than 20% of the previous five scaling intervals), the deviation threshold value is reduced as illustrated in operation 209, and resources are re-dimensioned and re-provisioned in operation 209 with the change of the deviation threshold value (e.g., when the deviation threshold value is decreased). In another example embodiment, when there is a frequent deviation (e.g., greater than 20% of the previous five scaling intervals), the deviation threshold value is reduced, and resources are re-dimensioned and re-provisioned as illustrated in operation 211. Thus for operation 211, if there is a spike, there may not be a need to wait for similar high deviation again. The reduced deviation threshold value will be achieved sooner and, thus, a response (e.g., re-dimensioning and re-provisioning) may be faster. Reduction of the deviation threshold value may be repeated, while deviations continue to be frequent, until the deviation threshold value is reduced to a minimum specified value (e.g., 5%).

In the example embodiment, when at the reduced deviation threshold value (e.g., 5%) frequently, the network traffic can stabilize and actual resource usage is within the dimensioning forecast bounds, and the deviation threshold value can be increased thereby increasing the dimensioning interval or reducing the dimensioning frequency. Thus, by increasing the dimensioning interval, until large (e.g., major) deviations occur, the resources are not re-dimensioned and re-provisioned. In other words, in some embodiments, when at a reduced deviation threshold value (and consequently increased dimensioning frequency or reduced dimensioning interval) the network traffic stabilizes and the actual resource usage is within the dimensioning forecast bounds, and the deviation threshold value can be increased thereby increasing the dimensioning interval or reducing the dimensioning frequency.

Potential advantages provided by various embodiments of the present disclosure may include that the dimensioning approach using Al/ML may not only automate the process to provide results immediately (after prior training), but also may cater to different data-availability scenarios. The method also may be proactive on a longer time-scale (i.e., the dimensioning interval), and reactive (or proactive) on a short time-scale (i.e., the scaling interval) as per an underlying orchestrator, through intelligent/adaptive dimensioning. An additional advantage may be fast deployment of resources, and may include low latency and with a level of fault tolerance. Further, the method avoid synchronization issues between an underlying cloud infrastructure provider and orchestrator; and may provide service (e.g., QoS) guarantees that may enable differential pricing for operators.

In various embodiments, the Al/ML model, data and knowledge driven telecommunications dimensioning models can cater to different data-availability scenarios, including (a) minimal, sufficient, and abundant data. The minimal data scenario may leverage public information sources or externally sourced benchmark data. Systems of current approaches do not include leverage of public information sources; (b) intelligent dimensioning for adaptive autoscaling; and (c) regression estimates include forecasts based on historical trends and forecasts based on anticipated subscriber growth and/or new service launches. Using domain knowledge, the latter can be translated to increases in predictor values applicable to the regression models of the former (models based on historical-data).

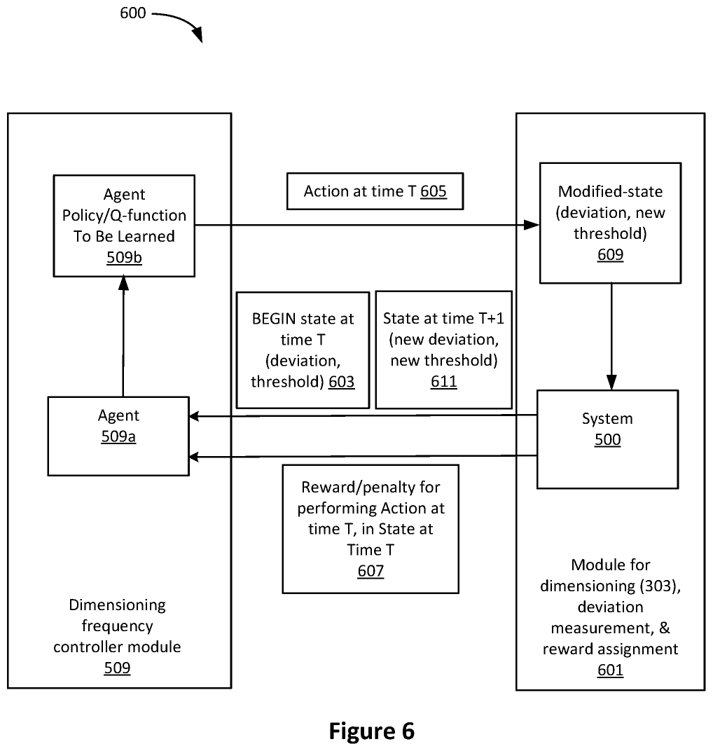

In various embodiments, provisioning resources for a dimensioning interval greater than a scaling interval can provide for:
(a) Making a rapid resource allocation. For example, attaching pre-provisioned VNFs into and out of service. This can be performed one time-step (e.g., on scaling interval) ahead (proactively) or reactively using any underlying orchestrator (see e.g., FIG. 6 and the corresponding description herein of FIG. 6);
(b) Removing coordination issues in multi-layer application infrastructure and, as a result, making the method cloud infrastructure provider and orchestrator agnostic;
(c) Enabling CSPs to provide QoS guarantees to customers willing to pay for it; and/or
(d) Enabling an operator to decide the dimensioning interval based on the customer-base and services the operator wants to offer. For example, a longer dimensioning interval may provide for more resources on standby. This may result in higher operating costs, but also a QoS (e.g., more capacity to respond to changes, which may result in lower chances of deviations occurring).
   Alternatively, a shorter dimensioning interval may provide for less resources on standby. This may result in less operating costs, but also a QoS (e.g., less capacity to respond to changes, which may result in higher chances of deviations occurring).

In various embodiments, use of an adaptive deviation threshold value to control the frequency of dimensioning and not the resource allocation directly (through, e.g., utilization thresholds) may provide: (a) dimensioning that results in resource provisioning as per forecast requirements; (b) dimensioning and provisioning more often during spikes and less often during stable traffic as a result of using the adaptive deviation threshold value. This can be performed by decreasing the deviation threshold value during times of frequent deviation and increasing the deviation threshold value at other times. Additionally, the deviation threshold value can be bounded. A lower deviation threshold value may result in deviations occurring sooner and, thus, re-dimensioning and re-provisioning occurs sooner. A higher deviation threshold value may result in deviations occurring less frequently and, thus, re-dimensioning and/or re-provisioning occurs less frequently; and/or (c) the adaption of the deviation threshold value may be performed using several Al/ML approaches including, without limitation, with reinforcement learning, contextual bandits, continuous optimization, etc., as further described herein.

An example embodiment for a minimal data scenario will now be described. A minimal data scenario includes, without limitation, pre-sales support and/or contract development for an initial deployment under consideration during formulation of a contract when historical data (e.g., PM counter data and operational data) from the customer is not available and, thus, public and/or benchmark data for a service or technology is used. The service or technology includes for example, and without limitation, an Internet service or an Internet-based application that is cloud deployed and uses underlying virtual resources (also referred to herein as resources).

Public and/or benchmark data includes data collected for a service of technology that may be comparable or useful with regard to the service/technology under contract consideration. Such public and/or benchmark data includes resource usage metrics for a service/technology as network traffic varied including, without limitation, CPU and/or memory usage for the service/technology and corresponding incoming/outgoing traffic to the service/technology including; traffic served, HTTPS requests served, number of active users, etc.; QoS metrics (e.g., delay, throughput, etc.); orchestration metrics (e.g., deployment, scaling, and/or reconfiguration time); and metrics associated with the deployed service/technology (e.g., average number of HTTPs requests, average query response time, packet processing time, etc.).

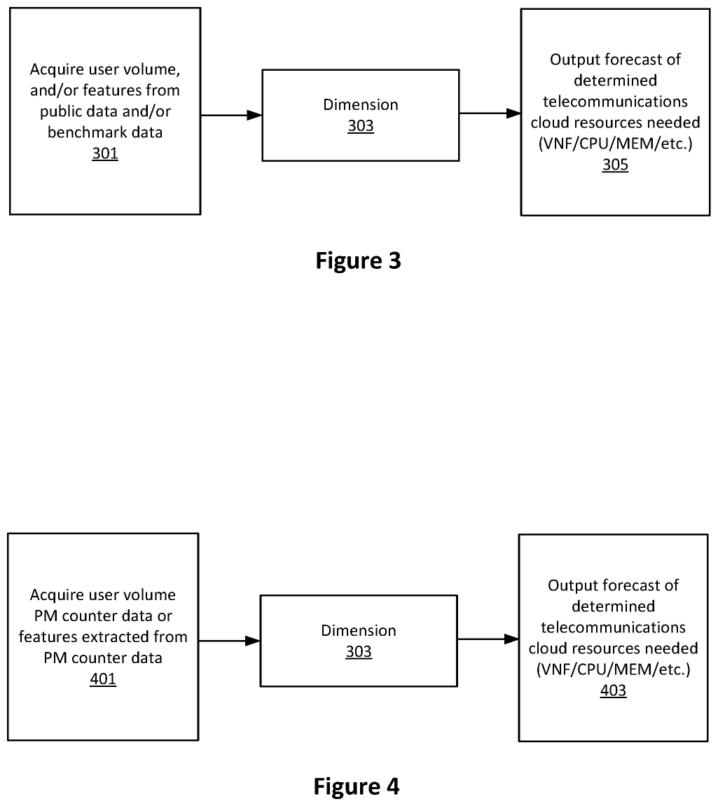

FIG. 3 is a flow chart of operations of an example embodiment for dimensioning for a minimal data scenario according to some embodiments of the present disclosure. Acquiring data 301 includes, without limitation, a user volume (e.g., a desired volume of subscribers), and/or features from public and/or benchmark data for a service or technology for which dimensioning is to be provided. For example, acquiring data 301 does not include PM counter data and operational data from the customer as it is not available in this example embodiment. By dimensioning 303, when no, or little, network traffic information is available, publicly available data is leveraged and/or externally sourced benchmark data are used to perform dimensioning. By performing dimensioning 303 on such data, a reasonable estimate of determined telecommunications cloud resources needed may be provided immediately despite having little to no data from the customer.

Still referring to FIG. 3, dimensioning 303 outputs a forecast of determined telecommunications cloud resources needed 305 (e.g., VNF, CPU, MEM, etc. needed). Dimensioning 303 can forecast the resources needed using, e.g., a regression function on the user volume, features from public data, features from external benchmark datasets, and/or the service or technology. Given few prior data points, dimensioning 303 can learn a regression model and apply the model to a test case to get a dimensioning estimate immediately.

An example embodiment for a sufficient data scenario will now be described. A sufficient data scenario includes, without limitation, initial network traffic data for a greenfield or a brownfield deployment (e.g., 3 to 7 days of network traffic data). Such network traffic data, when available, takes precedence over other types of data that can be included in a sufficient data scenario, such as public and/or benchmark data described above.

FIG. 4 is a flow chart of operations of an example embodiment for dimensioning for a sufficient data scenario according to some embodiments of the present disclosure. Acquiring data 401 includes, without limitation, some limited network traffic data showing resource usage metrics for the service/technology as network traffic varied (e.g., a few days data of, e.g., traffic features being considered for VNF dimensioning and/or busy-hour traffic statistics, peak throughput, network traffic for a new service/technology launch, subscriber growth for the service/technology, etc.) and/or minimal data as discussed above (e.g., a user volume (e.g., a desired volume of subscribers) for the service/technology, features from public and/or benchmark data for the service/technology for which dimensioning is to be provided. In some embodiments, public or benchmark data may or may-not be used; and an Al/ML regression algorithm can automatically estimate its relevance.

Still referring to FIG. 4, dimensioning 303 outputs a forecast of determined telecommunications cloud resources needed 403 (e.g., VNF, CPU, MEM, etc.). Dimensioning 303 can forecast the resources needed for the cloud-based service/technology using, e.g., a regression function on data showing resource usage metrics for the service/technology as network traffic varied (e.g., call/session/user-registration/call data record (CDR) volume features for the service/technology from features extracted from public or benchmark datasets and/or from the limited network traffic data (e.g., busy-hour data or data for a few days) for the service/technology acquired from the customer, etc.). Dimensioning 303 can include learning from training data and applying the model on a test data-set. In some embodiments, other features from data acquired are added as additional predictors.

In some embodiments, learning and applying the model is performed without explicit features and PM counter data is directly used with a Neural Network model. A potential advantage of such embodiments may include that there is no effort in selecting PM counters and/or defining features (also referred to as feature engineering).

Still referring to FIG. 4, in some embodiments, given few/limited prior data points for the deployed service/technology, dimensioning 303 can include learning a regression model and applying the model to a test case to get a dimensioning estimate immediately. Any regression model can be used.

An example embodiment for an abundant data scenario will now be described. An abundant data scenario includes, without limitation, adaptive data for a deployed, service that has to be managed.

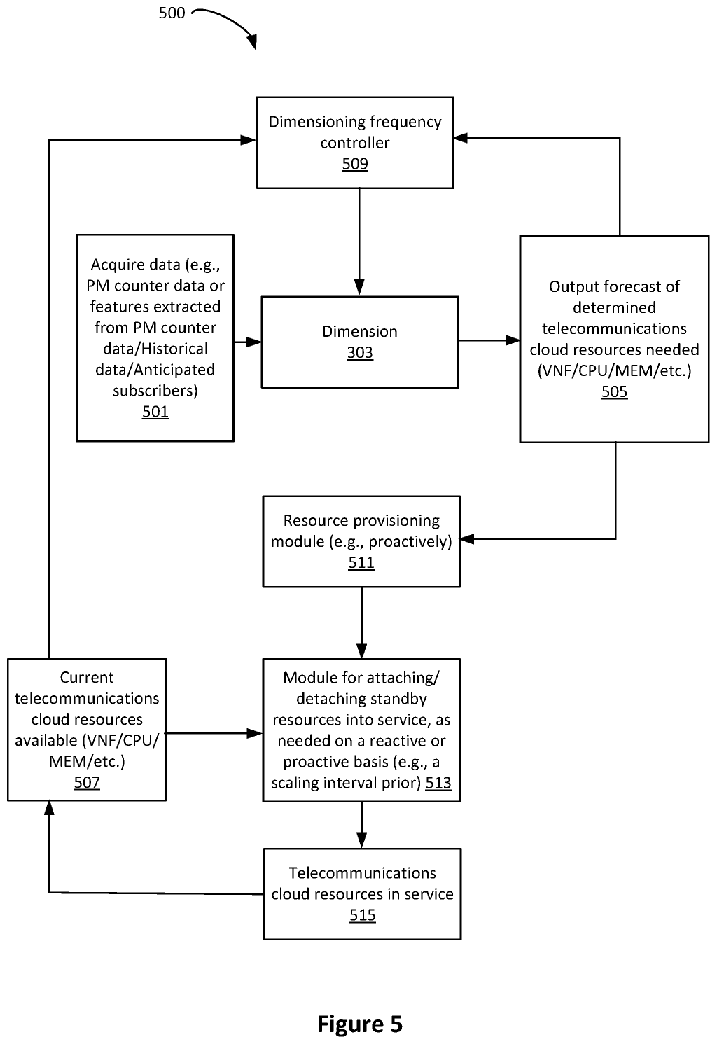

FIG. 5 is a flow chart of operations in a system 500 for adaptive dimensioning-driven provisioning of resources for a telecommunications cloud infrastructure according to some embodiments of the present disclosure. Acquiring data 501 includes, without limitation, acquiring several days streaming/full-day data and corresponding features for a deployed service/technology including resource usage metrics for the service/technology as network traffic varied (e.g., PM counter data or features extracted from PM counter data, historical data showing resource usage metrics for the service/technology as network traffic varied, and/or a volume of anticipated future subscribers for the service/technology, etc.). By using domain knowledge, forecasts based on anticipated subscriber growth and/or new service launches can be translated to increases in predictor values applicable to regression models based on historical-data.

Acquired data is provided for dimensioning 303 to obtain a forecast for a dimensioning interval (e.g., one hour ahead) that identifies bounds of minimum and maximum telecommunications resources needed (e.g., number of VNFs, amount of CPU units, amount of memory; or in terms of percentage of usage). Dimensioning 303 uses the acquired data to forecast the determined bounds of the telecommunications resources needed 505 (e.g., cloud resources including VNF, CPU, MEM, etc. needed) for the dimensioning interval, as described further herein. The forecasted determined bounds of the telecommunications resources are provided to dimensioning frequency controller module 509. Dimensioning frequency controller module 509 triggers dimensioning module 303 into operation. Dimensioning (that is, forecasting resources needed for a dimensioning interval) is performed according to a pre-set/defined dimensioning interval or whenever the deviation threshold value is breached (that is, a deviation occurs). In an example embodiment, assuming stable network traffic and a dimensioning interval of one hour ahead, the following can occur:
(1) After a first dimensioning interval lapses, if a deviation did not occur, dimensioning 303 is performed for the next dimensioning interval (i.e., the next hour in this example embodiment) which either (a) reuses the previous dimensioning forecast since no deviations occurred, this helps to minimize the total number of dimensioning operations performed; or (b) re-dimensioning 303 and re-provisioning 511 is performed for the next dimensioning interval; or
(2) Within the first dimensioning interval, if deviations occur, the deviation threshold value is changed by frequency controller module 509 and a re-dimensioning 303 followed by re-provisioning 511 is done for a further period of the dimensioning interval. Decreasing the deviation threshold value means that when a spike in network behavior occurs, the deviation threshold value may be breached sooner (that is, a deviation may occur sooner) and, thus, re-dimensioning 303/re-provisioning 511 may occur sooner. As a consequence, a QoS may not degrade or may not degrade as much as it would in the absence of this operation. Increasing the deviation threshold value to its maximum value means that re-dimensioning 303 is performed only when large deviations occur again or after the current dimensioning interval finishes without deviations (and thus, results in the two options 1(a) and 1(b) described above).

Still referring to FIG. 5, the forecasts of the telecommunications resources needed 505 are also provided to proactive resource provisioning module 511. Proactive resource provisioning module 511 provisions forecasted maximum resources and keeps those resources on standby for module 513 (e.g., an underlying orchestrator having auto-scaling capabilities) for attaching/detaching resources out of and into service 515 (e.g., standby resources) as determined based on the network traffic. Module 513, thus, attaches/detaches resources into and out of service 515 (e.g., stand-by resources) as determined based on network traffic on a reactive or proactive basis (e.g., predicting resources needed one scaling interval ahead). An identification of the telecommunications resources in service is provided to module 513 and to current telecommunications resources available 507, which are provided to dimensioning frequency controller module 509.

In some embodiments, the resource provisioning module 511 is an orchestrator (e.g., Kubernetes) and the module 513 for attaching provisioned resources into and out of service is implemented by traffic management and service-mesh mechanisms operating over the resources provisioned by the orchestrator (e.g., Istio on a Kubernetes cluster). The orchestrator (e.g., Kubernetes), functioning as the resource provisioning module 511, operates at the frequency of the dimensioning interval (e.g., 1 hour) and when the orchestrator receives forecast 505 of determined resources needed, whereas the traffic management mechanism (e.g., Istio on a Kubernetes cluster) that attaches or detaches resources into or out of service, operates at a much higher frequency (e.g., 5 mins, which is a the typical scaling interval of autoscalers in use today). While embodiments discussed herein are explained in the non-limiting

context of different modules, the invention is not so limited. Instead, other components or tools available in the state of the art and apparent to those skilled in the art may be used to perform operations according to embodiments disclosed herein. Other systems, computer program products, and methods according to embodiments will be or become apparent to one with skill in the art upon review of the drawings and detailed description. It is intended that all such additional systems, computer program products, and methods be included within this description and protected by the accompanying claims.

In some approaches in the industry, proactive autoscaling may have used a resource forecast for the (short, e.g., every minute) duration of a next scaling interval; which may require continuous forecasting and re-provisioning. Such approaches also may suffer from synchronization issues leading to increased latency and poor QoS (e.g., with the underlying cloud infrastructure provider). They also may be very sub-optimal in the number of forecasting operations they have to perform.

Referring again to FIG. 5, in various embodiments of the present

disclosure, autoscaling is performed by dimensioning (e.g., for a longer time period (that is, a dimensioning interval) such as 1+hours), provisioning resources (e.g., on standby or in hot-swap mode), and deploying resources only when required by module 513 (e.g., an underlying orchestrator). Potential advantages of embodiments of the present disclosure may include that the method may: be proactive on a longer time-scale, reactive (or proactive) on a short time-scale; deploy resources very fast, with low latency and with a level of fault-tolerance; avoid synchronization issues between underlying cloud infrastructure provider and an orchestrator; and/or may provide service (QOS) guarantees that may enable differential pricing for operators.

In some embodiments, an adaptive deviation threshold value is used that adapts re-dimensioning frequency to network traffic (e.g., the deviation threshold value is low during spikes).

In some embodiments, continuous re-dimensioning and/or re-provisioning is performed as provided by continuous re-measurement of deviation. As used herein, the term “re-dimensioning” refers to re-calculating the dimensioning (also referred to herein as a forecast) including recent network data trends/changes or newly understood behavior. As used herein, the term “re-provisioning” of resources refers to an increase or a decrease of resources (e.g., VNFs, CPUs, MEMs, etc.) according to a dimensioned output (e.g., a most recent dimensioned output), including de-provisioning resources that are not being used. The term “continuous” includes, without limitation, periodic (e.g., re-dimensioning every 12 hours or twice a day or measuring deviation every 5 minutes (in one embodiment) to every 15 minutes (in another embodiment), as well as adhoc on limited occasions, as needed. In various embodiments, the method determines a frequency for re-dimensioning and/or re-provisioning given current traffic conditions.

In some embodiments, a regression model can use multiple and/or multivariate forward-prediction (i.e., forecasting). Both parametric (vector auto-regressive models (VAR), long short-term memory neural network model (LSTM), Tree/ensemble models, etc.) and non-parametric Gaussian Process(GP) models may be explored for multivariate treatment. Forecasting can be performed with multiple time-series, features and a component (e.g., CPU/MEM/VNF etc.). Forecasting with multiple time-series, features, and multiple components also can be performed to leverage correlations between them.

In some embodiments, the data includes historical data from PM counters and/or features derived from them. Data can also include data for a new service launch and subscriber growth. The Al/ML model, therefore, can be a single model that uses all of these features, or can be a combination of two separate models. For a single model, domain knowledge can be used to translate anticipated subscriber growth into increases in predictors of the existing model. For a combination of two separate models, one model essentially forecasts based on historical data (as described above), and the other model predicts resources needed from anticipated additional services/subscribers (e.g., a domain-knowledge based model that directly estimates resources required given an anticipated subscriber volume).

In some embodiments, a frequency and/or deviation threshold value for re-dimensioning and re-provisioning is addressed using Reinforcement Learning (RL) (as described further herein). Other Al/ML models such as Contextual Bandits (e.g., a simplification of RL), Continuous Optimization, etc. may also be used.

In some embodiments (e.g., for an abundant data scenario), a frequency and/or deviation threshold value for re-dimensioning and re-provisioning is performed without explicit features and only PM counter data (as described herein).

An example embodiment for handling data-drift in a continuous deployment scenario is now described. Data drift may manifest in at least two ways: (1) drift leading to inaccurate dimensioning, and (2) drift leading to less or over-sensitive action selection during different traffic conditions.

For drift leading to inaccurate dimensioning, in some embodiments, re-dimensioning means re-predict, or re-model (due to drift) and then re-predict. In some embodiments, re-modeling can be initiated whenever re-dimensioning is done, or when the actual-forecast deviation exceeds another (e.g., user-defined) deviation threshold value.

For the example embodiments described above, drift may occur in the forecasting model for historical data and/or the prediction (regression) model for anticipated future services/subscribers. In other embodiments, a separate threshold can be learned (as described further herein).

For drift leading to less or over-sensitive action selection during different traffic conditions, system (action-value or policy model) can use re-training whenever the rewards in multiple consecutive time-horizons fall-below a certain (e.g., user-defined) reward threshold value. This condition suggests that the action selection is generally not appropriate for the current circumstances. This drift scenario is less likely as RL is applied to control the frequency of dimensioning and not directly the autoscaling of resources. The behavior (e.g., ideal behavior) of the controller is unlikely to change significantly with changing network traffic.

Example embodiments for re-dimensioning and re-provisioning are now described. These example embodiments include re-dimensioning that results in provisioning or de-provisioning of resources potentially needed in the near term (e.g., until the next dimensioning or, e.g., 1+hours). Provisioned resources are kept in standby or hot-swap mode for deployment by an orchestrator as needed.

As used herein, actual resources refers to current resources available. As used herein the term “forecast” refers to a forward projection of resources needed. As used herein, the term “deviation” refers to an excess of actual resources over forecast-maximum resources, or to the less of actual resources under forecast-minimum resources. As used herein, the phrase “deviation threshold value” refers a value defining a maximum allowed deviation under a minimum bound of usage of at least one resource and a maximum allowed deviation over a maximum bound of usage of the at least one resource for the dimensioning interval. Thus, the deviation threshold value can be a value having a magnitude ranging from a defined (e.g., user-defined) lower-bound to an upper-bound. For example, a deviation threshold value may be from 1% to 10%; and if at the minimum-deviation threshold value, deviations >10% still occur, it may be a case of data-drift needing model re-training. Resource amounts can be expressed in unit (e.g., VNF resources expressed as VNF units, CPU resources expressed in MHz, or memory resources expressed in GB, etc.).

The method of various embodiments may provide potential advantages including adaptive re-dimensioning and re-provisioning given network traffic using a minimum re-dimensioning and re-provisioning frequency (e.g., a maximum deviation threshold value). The method may proactively avoid potential synchronization issues between orchestration of telecommunications cloud resources (e.g., VNFs, etc.) and that of underlying virtual machines (VMs). Additionally, the method may avoid idle resources subject to above (that is, the method is bounded); and the method may avoid congestion due to insufficient resources leading to denial of service.

FIG. 6 is a block diagram of elements, and flow of operations of for training a dimensioning frequency controller (e.g., 509) of a system (e.g., system 500), in accordance with some embodiments of the present disclosure. FIG. 6 illustrates operations for training the dimensioning frequency controller (e.g., 509) so the dimensioning frequency controller can operate in system 500 as shown in FIG. 5. The example embodiment of FIG. 6 includes dimensioning frequency controller 509 which interacts with module 601 which performs dimensioning 303, deviation measurement, and reward assignment for training to dimensioning frequency controller 509. Dimensioning frequency controller module 509 includes Al/ML model (also referred to herein as an “Agent”) 509a. Training of Agent 509a is the learning of an Agent Policy or Q-function 509b that enables dimensioning frequency controller module 509 to take accurate decisions on adjusting the deviation threshold value (that is, deciding to increase the deviation threshold value, decrease the deviation threshold value, or do nothing) given deviations observed. Training is performed by Agent 509a interacting with the system 500 and learning to take decisions that maximize rewards for Agent 509a.

Still referring to FIG. 6, operations of FIG. 6 begin at 603. Starting at time T, Agent 509a receives a notion of the current state (or context, in Contextual Bandits) that may encode a measure of deviation and/or the current deviation threshold value. The measure of deviation of actual resources consumed relative to the dimensioned estimate (for the dimensioning interval) may be encoded for one or more previous time-steps. Time-steps may span scaling intervals of the underlying orchestrator. Given the current state, at operation 605, the Agent 509a chooses an appropriate action. Different action-sets exist (including doing nothing, increasing the deviation threshold value, decreasing the deviation threshold value, and re-dimensioning/re-provisioning) depending on the application setting requirements. On selecting an action in each state and performing it, in operation 607, the Agent 509a receives a reward value (or a penalty value). The objective of training the Agent 509a by having it interact with the system is to learn 509b conditional probabilities for different actions to be performed in different states, to thereby select actions that maximize rewards over time. Referring now to operation 609, training will encourage the Agent 509a to decrease the deviation-threshold value during spikes and increase the deviation threshold value during times of stable traffic. In operation 611, at the next time-step interval, T+1, the Agent 509a receives the next state/context observed. The training continues until the Agent 509a consistently gets high rewards. Training may be achieved through different Al/ML approaches such as Reinforcement Learning, Contextual Bandits, Continuous Optimization etc. After training, dimensioning frequency controller module 509 is ready to be deployed in the system 500 depicted in FIG. 5.

According to some embodiments, the elements of FIG. 6 are included in a network node that includes components for dimensioning 303, resource provisioning 511, and dimensioning frequency controller 509. The network node, and/or an element(s)/function(s) thereof, which may be embodied as a virtual node/nodes and/or a virtual machine/machines.

While the above description of FIG. 6 provides one example of states, actions, and rewards for training an Al/ML model included in a dimensioning frequency controller (e.g., 509) of a system (e.g., system 500), the training is not so limited. Training includes various different options for states, actions, rewards/penalties, and definitions of deviations. The following are example embodiments of training that include various different states, actions, rewards/penalties, and definitions of deviations.

In a first example embodiment, no training is required as a fixed deviation threshold value is set (e.g., by a user based on data or prior trends or experience). Thus, Agent Policy 509b is fixed and, therefore, the Agent 509a need not interact with the system 500 to learn the Agent Policy 509b. In this example embodiment, the deviation threshold value is non-adaptive. The fixed deviation threshold value is used for re-dimensioning and re-provisioning resources. In the example embodiment, whenever a deviation (e.g., max(actual -forecast-max, forecast-min -actual, 0.0) exceeds the fixed deviation threshold value, an action of re-dimensioning followed by re-provisioning is performed. Thus, both upward and downward spikes are taken care of. The fixed deviation threshold value used in training can be arbitrarily chosen, or can be chosen from historical data-trends.

In a second example embodiment, an adaptive deviation threshold value is used for re-dimensioning and re-provisioning. An adaptive deviation threshold value can be used when, e.g., a fixed threshold may not respond fast enough; or a fixed deviation threshold value would result in over or under re-dimensioning/re-provisioning, etc. An adaptive deviation threshold value refers to changing the deviation threshold value based on network traffic. For example, depending on seasonality (e.g., festivals/events) and unforeseen changes (e.g., churn, sudden mass-subscription, response to plans, VNF malfunction, etc.).

Depending on deviation magnitude during spikes, it may be useful to re-dimension and re-provision more often to avoid poor QoS by reducing the deviation threshold value. Once deviation is low and consistently within the current deviation threshold value, it makes sense to increase the deviation threshold value to a defined maximum value, which may reduce re-dimensioning and re-provisioning events which have associated costs. In some embodiments, the method includes a RL model as AI/ML model 509a, which may achieve this goal. For example, if a defined deviation threshold value is 10%, after the first instance, waiting for a 10% deviation to re-occur during a spike may be detrimental for both the service provider and for customers. Thus, in some embodiments, the method reduces the deviation threshold value slightly. If deviation continues, the deviation threshold value is reduced to the minimum. The method continues performing re-dimensioning and re-provisioning, while decreasing the deviation threshold value. Once the situation stabilizes, the deviation threshold value can be increased to reduce the frequency of re-dimensioning and re-provisioning.

In another example embodiment, a state (“s”) (e.g., blocks 603, 605, 611 of FIG. 6) includes the following:
s0=deviation=max(actual -forecast-max, forecast-min -actual, 0.0)
s1=(s0<deviation threshold value) or (s0 >deviation threshold value) (that is, no-deviation or deviation state)
s2=count/proportion of being in each s1 state in the last n measurements
   2d vector (c1, c2) with c1+c2=n (where c1 >no-deviation, and c2>deviation)
   Additionally, only c2 can be captured and only penalties can be relied on (rather that rewards as described further below)
s3=current deviation threshold value
state vector=(s2, s3)
   where s2 influences action selection and both s2, s3 (value after performing action) and/or the chosen action influence the reward returned (block 609 of FIG. 6). For example, s2 and the chosen action can decide the reward returned.

This example embodiment includes actions (block 607 of FIG. 6): do nothing; increase deviation threshold value by a delta; re-dimension and re-provision and decrease the deviation threshold value by a delta.

In this example embodiment, a suitably crafted reward function residing in 601 (block 609 of FIG. 6 returns a reward/penalty value to Agent 509a) may exhibit any subset of the following behaviors or characteristics:
Penalize s2 (c2), i.e., deviations
Reward s2 (c1), i.e., non-deviations
Penalize s3 value after performing action (e.g., its value relative to the upper bound (e.g., 10%))
Penalize “illegal” action selections, e.g., selecting to increase the deviation threshold value when already at the upper-bound or selecting to decrease the deviation threshold value when already at the lower-bound
By weighing the s2 penalty more than that of s3, the deviation threshold value gets set so as to avoid frequent deviations. By including an s3 penalty component, the largest such deviation threshold value is preferred.

In this example embodiment, the training of dimensioning frequency controller module 509 includes other approaches including RL, contextual bandits, and continuous optimization. In a first approach, a policy gradient (PG) (e.g., RL/proximal policy optimization (PPO)) is used for Agent Policy 509b with three possible actions (block 607 in FIG. 6) as described above, or a single continuous outcome representing the change to be affected on the deviation threshold value from its current value. Instead of RL, simplifications in terms of contextual-bandits or continuous optimization can also be used subject to appropriate assumptions. In a second approach, Q-learning (e.g., Deep-Q network (DQN)) using random-sampled sequences of n+h experience steps can be used where n is the number of measurement time-steps used to encode the state at a given time-step and h is the length of the horizon used in Q-learning. Either use of an s2×3 table or use of a neural network function approximator of the Q-function taking (s2, s3) as input and producing a 3-dim output vector that is used for action selection. PG, PPO, Q-learning, and DQN, etc. are specific algorithms within RL. PG and PPO also can be applied to contextual bandits.

In this example embodiment, Agent 509a effectively learns the following behavior at each measurement time-step:
if the deviation is mostly<the deviation threshold value
   if s3 is maximum, do nothing
   if s3 is <maximum, increase threshold gradually (and thereby decrease re-dimensioning/re-provisioning frequency)
if deviation >the deviation threshold value frequently
   re-dimension/re-provision and decrease the deviation threshold value gradually (and thereby increase re-dimensioning/re-provisioning frequency)
Basically, during spikes, re-dimensioning/re-provisioning frequency will increase and then fall back when actuals are steady within re-dimensioning forecasts.

In some embodiments, if there are slow response to spikes because the deviation threshold value is decreased gradually, when deviations become frequent over n observations, the following example embodiment provides a different action-set.

In the next example embodiment, adaptive deviation threshold value selection and a fast response to spikes are included. This embodiment is identical to the example embodiment above except for a change in the action set (block 607 in FIG. 6) as follows:

### Action

Do nothing
Increase deviation threshold value by a delta (and thereby reduce re-dimensioning/re-provisioning frequency)
Re-dimension/re-provision and decrease deviation threshold value to its minimum value (and thereby increase re-dimensioning/re-provisioning frequency to maximum)

For smaller deviations, this example embodiment may “over-compensate”. Another example embodiment can be performed for gradual deviation threshold value changes and the last action above is only performed when deviations are large. Thus, this example embodiment is like having one explicit threshold (for gradual threshold changes) and one implicit threshold (strong response), as further described below.

In the next example embodiment, adaptive deviation threshold value selection and a fast response to large spikes are included. In this example embodiment, states (e.g., blocks 603, 605, 611 of FIG. 6) include the following:
s0=deviation=max(actual -forecast-max, forecast-min -actual, 0.0)
   This can be for the current time-step alone or can factor the values for each of the previous n measurements
s1=(s0≤ deviation threshold value) or (s0 >deviation threshold value) (that is, no-deviation or deviation state)
s2=count/proportion of being in each s1 state in the last n measurements
   2d vector (c1, c2) with c1+c2=n (where c1=>no-deviation, c2=>deviation)
   Additionally, only c2 can be captured and only penalties can be relied on (rather that rewards as described further below)
s3=current threshold
state vector=(s0, s2, s3)
   where (s0, s2) influence action selection, s0, s2, s3 (value after performing action) and/or the chosen action influence reward returned

In this example embodiment, actions (block 607 in FIG. 6) include the following:
Do nothing
Re-dimension/re-provision and decrease deviation threshold value to minimum (and/or maximum re-dimension/re-provision frequency)
Increase deviation threshold value by delta (and/or reduce re-dimension/re-provision frequency)
Decrease deviation threshold value by a delta (and/or increase re-dimension/re-provision frequency) and perform re-dimensioning followed by re-provisioning

In this example embodiment, a suitably crafted reward function (block 609 in FIG. 6) may exhibit any subset of the following behaviors or characteristics:
Penalize s0
Penalize s2 (c2)
Reward s2 (c1)
Penalize if re-dimension/re-provision performed
Penalize s3 value after performing action (e.g., its value relative to the pre-defined upper bound (e.g., 10%))
Penalize “illegal” action selections, e.g., selecting to increase the deviation threshold value when already at the upper-bound or selecting to decrease the deviation threshold value when already at the lower-bound
By weighing the s2 penalty more than that of s0 and s3, min-threshold for large deviations is encouraged. This action exists to respond quickly to large/rapid spikes. By choosing this action, the system (e.g., the dimensioning module 303 and/or the dimensioning frequency controller module 509) will learn that responding to large deviations (e.g., large s0) needs more than a gradual change to ensure staying within threshold (e.g., maximize s2(c1) and minimize s2(c2)) most of the time. By penalizing re-dimension/re-provision occurrences more than s3 (deviation threshold value value), this option is used less often (e.g., in more extreme cases) than simply decreasing the re-dimensioning frequency.

In this example embodiment, the Al/ML learning and training approach 509a/509b includes options. In a first option, a PG approach (e.g., RL/PPO) is used with four possible actions as described above, or a single continuous outcome representing the change to be affected on the deviation threshold value from its current value. Instead of RL, simplifications in terms of contextual-bandits or continuous optimization can also be used subject to appropriate assumptions. In a second option, Q-learning (e.g., DQN) using random-sampled sequences of n+h experience steps can be used where n is the number of measurement time-steps used to encode the state at a given time-step and h is the length of the horizon used in Q-learning. Use of a neural network function approximator of the Q-function taking (s0, s2, s3) as input and producing a 4-dim output (action-value) vector for subsequent action selection.

At each measurement time-step, Agent 509a effectively learns the following behavior:
if the deviation is mostly≤ the deviation threshold value
   if s3 is maximum, do nothing
   if s3 is <maximum, increase threshold gradually (and thereby decrease re-dimensioning/re-provisioning frequency)
if deviation >the deviation threshold value frequently
   Decrease deviation threshold value gradually (and thereby increase re-dimension/re-provision frequency) and re-dimension and re-provision resources.
In addition to frequent deviations, if deviation magnitude is also large
   re-dimension/re-provision and decrease the deviation threshold value to minimum (and/or increase re-dimensioning/re-provisioning frequency to maximum)

Basically, during spikes, re-dimensioning/re-provisioning frequency will increase and then fall back when actuals are steady within re-dimensioning forecasts.

In another example embodiment, adaptive deviation threshold value selection and separate thresholds for increasing/decreasing spikes are included. In this example embodiment, states (e.g., blocks 603, 605, 611 in FIG. 6) include the following:
s0=deviation=max(actual -forecast-max, forecast-min -actual, 0.0)
   This can be for the current time-step alone or can factor the values for each of the previous n measurements
s1=
   insufficient resources if s0 >0.0 and actual >forecast-max+thresh1
   appropriate resources if s0=0.0
   unutilized resources if s0 >0.0 and actual <forecast-min -thresh2
s2=count/proportion of being in each s1 state in the last n measurements
   3d vector (c1, c2, c3) with c1+c2+c3=n. (where c1=>insufficient, c2=>appropriate, c3=>unutilized)
s3=current thresholds (thresh1, thresh2) where each can range from a lower to upper bound (e.g.,1-10%)
state vector=(s0, s2, s3)

In this example embodiment, actions (block 607) include the following:
Do nothing
Re-dimension/re-provision and decrease thresh1 to minimum allowed value (=>maximum re-dimension/re-provision frequency)
Increase thresh2 by delta (=>reduce re-dimension/re-provision frequency)
Re-dimension/re-provision and decrease thresh2 by delta (=>increase re-dimension/re-provision frequency)
Increase thresh1 by delta (=>reduce re-dimension/re-provision frequency)
Re-dimension/re-provision and decrease thresh1 by delta (=>increase re-dimension/re-provision frequency)

In this example embodiment, a suitably crafted reward function (block 609 of FIG. 6) may exhibit any subset of the following behavior or characteristics:
Penalize s0
Penalize s2 (c1) and s2 (c3)
Reward s2 (c2)
Penalize if re-dimension/re-provision performed (s3 can include an extra Boolean flag for this)
Penalize s3 value after performing action (e.g., each value relative upper bound (e.g., 10%))
Penalize “illegal” action selections, e.g., selecting to increase the deviation threshold value when already at the upper-bound or selecting to decrease the deviation threshold value when already at the lower-bound
By weighing s2 (c3) penalty more than s2(c1), s0 and s3 -min-threshold is encouraged for large deviations in increasing spikes. This may enable a quick response to large/rapid spikes. By choosing this action, the Al/ML model 509a/509b may learn that responding to large deviations in increasing spikes needs more than a gradual change to ensure staying within threshold most of the time. For downward spikes, the change can be gradual.

In this example embodiment, agent 509A effectively learns the following behavior:
Minimize s2(c1)=deviations (insufficient) in last n measurements
Minimize s2(c3)=deviations (unutilized) in last n measurements
Maximize s2(c2)=set deviation threshold value to stay within it
Maximize thresholds (i.e., minimize re-dimension/re-provision frequency)
In one option, PG approaches (e.g., Policy Gradient Reinforcement Learning approaches-Proximal Policy Optimization (REINFORCE/PPO)) can be used with 6 possible actions as above, or two continuous outcomes representing the change to be affected on each threshold, from its current value.
   Instead of RL, simplifications in terms of contextual-bandits or continuous optimization can also be used subject to appropriate assumptions.
In another option, Q-learning (e.g., DQN) can be used using randomly-sampled sequences of n+h experience steps where n is the number of measurement time-steps used to encode the state at a given time-step and h is the length of the horizon used in Q-learning; a neural network function approximator of the Q-function can be used taking (s0, s2, s3) input and producing a 6-dim output vector for subsequent action-selection.
At each measurement time-step, agent 509a effectively exhibits the following behavior:
   if s1=appropriate most often
      if thresh1 is maximum, do nothing else increase gradually (and thereby decrease re-dimension/re-provision frequency)
      if thresh2 is maximum, do nothing else increase gradually (and thereby decrease re-dimension/re-provision frequency)
   if s1=insufficient or unutilized infrequently and s0 is not large
      Perform re-dimensioning followed by re-provisioning and decrease thresh1 or thresh2 (respectively) gradually (and thereby increase re-dimension/re-provision frequency)
   if s1=insufficient often and s0 is large
      Perform re-dimensioning followed by re-provisioning and decrease thresh1 to minimum (and thereby increase re-dimension/re-provision frequency to maximum)
Basically, during increasing spikes, re-dimension/re-provision frequency will increase, potentially to its maximum allowed value, and then fall back when actual resource requirements are steady within re-dimensioning forecasts. During decreasing spikes, re-dimension/re-provision frequency will increase only gradually and then gradually fall back when actuals are steady within re-dimensioning-forecasts.

It is noted that in the above example embodiments, the reward (609 in FIG. 6) can also include a component capturing the number of changes to the deviation threshold value in the last n time-steps to discourage frequent deviation threshold value changes. As appropriate, in some embodiments, deviation values and/or deviation threshold values can be quantized to simplify implementation and computational complexity.

It is also noted that in the above example embodiments, other RL approaches can be used are not limited to the example RL approaches discussed above.

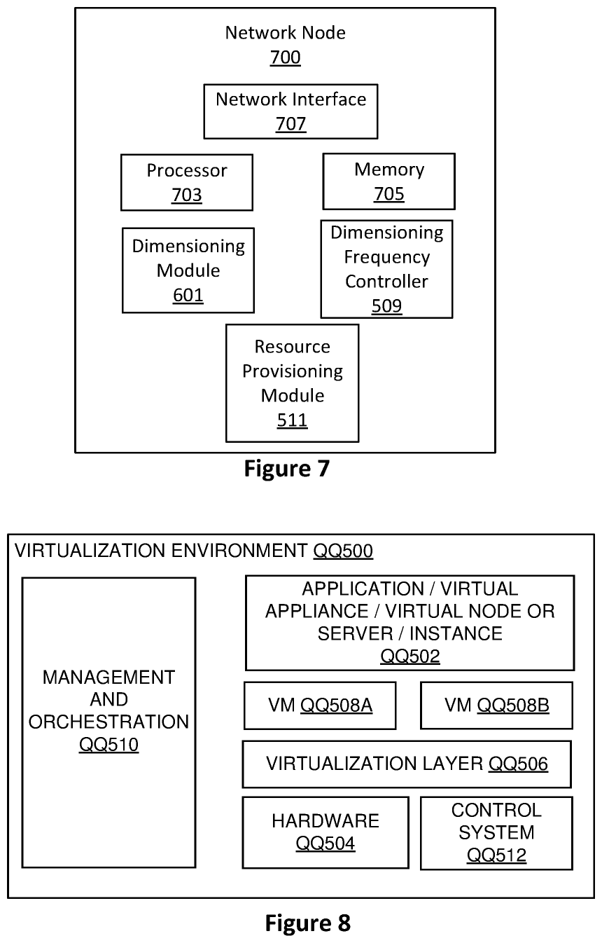

FIG. 7 is a block diagram illustrating elements of a network node configured to perform operations and provide communication according to embodiments of the present disclosure. As shown, the network node may include network interface circuitry 707 (also referred to as a network interface) configured to provide communications with other nodes of the telecommunications network. The network node may also include a processing circuitry 703 (also referred to as a processor) coupled to the network interface circuitry, and memory circuitry 705 (also referred to as memory) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required. The network node also may include dimensioning module 601 (e.g., for performing dimensioning 303), dimensioning frequency controller 509, and resource provisioning module 511.

As discussed herein, operations of the network node may be performed by processing circuitry 703 and/or network interface circuitry 707 (e.g., operations of dimensioning module 601, dimensioning frequency controller 509, and resource provisioning module 511). Additionally, processing circuitry 703 may control network interface circuitry 707 to transmit communications through network interface circuitry 707 to one or more other network nodes, VNFs, CPUs, memory, etc. and/or to receive communications through network interface circuitry from one or more other network nodes, VNFs, CPUs, memory, etc. Moreover, modules may be stored in memory 705, and these modules may provide instructions so that when instructions of a module are executed by processing circuitry 703, processing circuitry 703 performs respective operations (e.g., operations discussed herein with respect to example embodiments relating to network nodes). As described above, according to some embodiments, network node 700 and/or an element(s)/function(s) thereof may be embodied as a virtual node/nodes and/or a virtual machine/machines including, without limitation e.g., dimensioning module 303 and dimensioning frequency controller modules 509.

FIG. 8 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510 (also referred to herein as an “orchestrator” (e.g., module 513 in FIG. 5)), which, among others, oversees lifecycle management of applications QQ502. In various embodiments of the present disclosure, orchestration is separated into provisioning or de-provisioning implemented by proactive resource provisioning 511 and attaching or detaching of (pre-provisioned) telecommunications cloud applications/services/technology into and out of service which, as a consequence, QQ510 can perform more rapidly and without synchronization issues with underlying cloud infrastructure providers. This also enables the method of the present disclosure to be orchestrator and cloud infrastructure provider agnostic. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

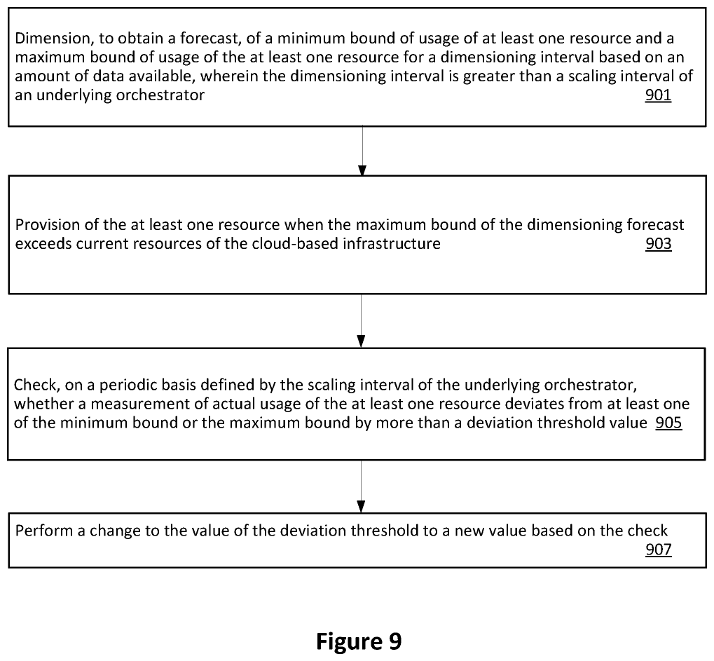

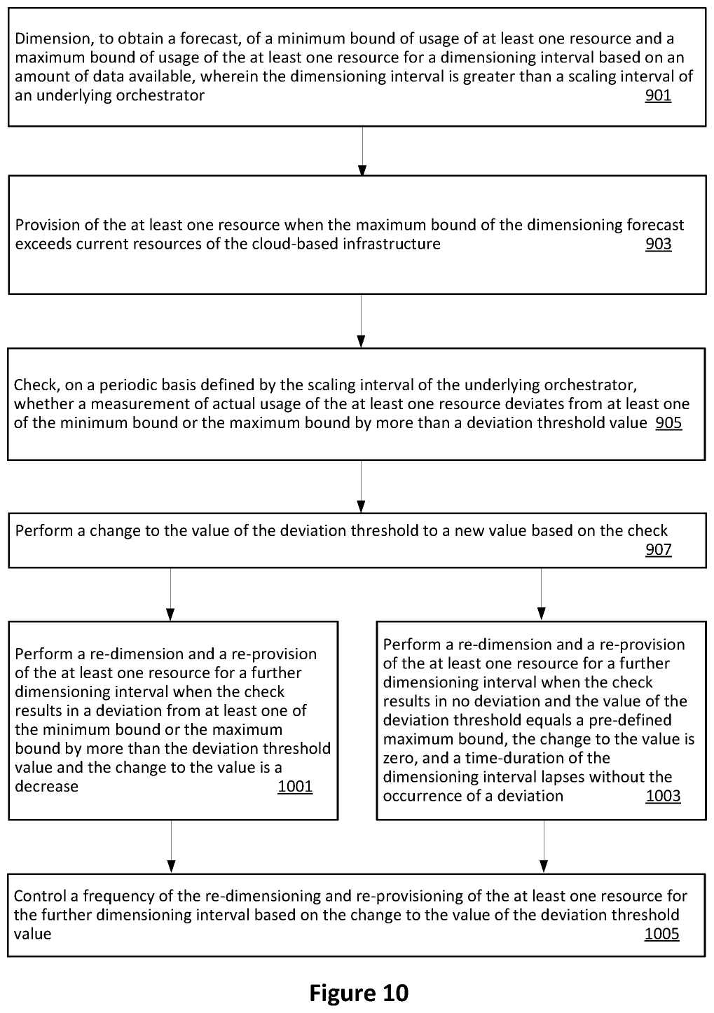

Now that the operations of the various components have been described, operations specific to a network node (e.g., network node 101 implemented using the structure of the block diagram of FIG. 7) will now be discussed with reference to the flow charts of FIGS. 9-10 according to some embodiments of inventive concepts. For example, modules may be stored in memory 705 of FIG. 7, and these modules may provide instructions so that when the instructions of a module are executed by respective network node processing circuitry 703, processing circuitry 703 performs respective operations of the flow charts of FIGS. 9-10.

Each of the operations described in FIGS. 9 and 10can be combined and/or omitted in any combination with each other, and it is contemplated that all such combinations fall within the spirit and scope of this disclosure.

Referring first to FIG. 9, a method is performed by a network node (e.g., 101, 700) for adaptive dimensioning and provisioning at least one resource of a cloud-based infrastructure of a telecommunications network (e.g., 100), the method being orchestrator and cloud infrastructure agnostic. The method includes dimensioning (901), to obtain a forecast of, a minimum bound of usage of the at least one resource and a maximum bound of usage of the at least one resource for a dimensioning interval based on an amount of data available. The dimensioning interval is greater than a scaling interval of an underlying orchestrator. The method further includes provisioning (903) of the at least one resource when the maximum bound of the dimensioning forecast exceeds current resources of the cloud-based infrastructure. The method further includes checking (905), on a periodic basis defined by the scaling interval of the underlying orchestrator, whether a measurement of actual usage of the at least one resource deviates from at least one of the minimum bound or the maximum bound by more than a deviation threshold value. The method further includes performing (907) a change to the value of the deviation threshold to a new value based on the checking.

Referring now to FIG. 10, in some embodiments, the change to the value is a decrease when the checking (905) results in a deviation from at least one of the minimum bound or the maximum bound by more than the deviation threshold value; and the method further includes performing (1001) a re-dimensioning and a re-provisioning of the at least one resource for a further dimensioning interval.

In some embodiments, the change to the value is an increase when the checking (905) results in no deviation and the value of the deviation threshold is less than a pre-defined maximum bound.

In some embodiments, the change to the value is zero when the checking (905) results in no deviation and the value of the deviation threshold equals a pre-defined maximum bound; and the method further includes performing (1003) a re-dimensioning and a re-provisioning of the at least one resource for a further dimensioning interval when a time-duration of the dimensioning interval lapses without the occurrence of a deviation.

In some embodiments, the performing (1003) the re-dimensioning and the re-provisioning re-uses the dimensioning and the provisioning of the previous dimensioning interval.

The method of FIGS. 9 and 10, as explained above, includes provisioning (903) of the at least one resource when the maximum bound of the dimensioning forecast exceeds current resources of the cloud-based infrastructure; conversely, when the current resources exceeds the maximum-bound of the dimensioning forecast and unutilized resources are available, de-provisioning of the at least one resource occurs. As used herein, unless otherwise noted, the term “provisioning” (and “re-provisioning”) refers to provisioning or de-provisioning as required.

Still referring to FIG. 10, in some embodiments, the method includes further operations for controlling (1005) a frequency of the re-dimensioning and re-provisioning of the at least one resource for the further dimensioning interval based on the change to the value of the deviation threshold value.

Referring again to FIG. 9, in some embodiments, the performing (907) a change includes using a machine learning model for at least one of to change the deviation threshold value or to initiate the re-dimensioning followed by the re-provisioning, based on network traffic behavior. The network traffic behavior being the measurement of actual usage of the at least one resource that deviates by more than the deviation threshold value compared to the bounds of usage of the forecast obtained from the dimensioning.

In some embodiments, the controlling (1005) the frequency of the re-dimensioning and re-provisioning of the at least one resource for the further dimensioning interval based on the changing the value of the deviation threshold value comprises a reduction in the frequency when the value of the deviation threshold value increases, and an increase in the frequency when the value of the deviation threshold value decreases. A lower deviation threshold value can be breached sooner and a higher deviation threshold value can take longer to breach. Frequent breaches of the deviation threshold value result in re-dimensioning and re-provisioning.

In some embodiments, the amount of data available is in a range from a minimum amount of data to a maximum amount of data.

In some embodiments, the minimum amount of data comprises a number of subscribers and network traffic metrics when deploying a specific service.

In some embodiments, the maximum amount of data comprises at least one of streaming data from the telecommunications network, historical data from the telecommunications network, features derived from historical data from the telecommunications network, and data on new services or new subscribers for the future for the telecommunications network.

In some embodiments, the at least one resource includes at least one of a virtual network function (VNF), a unit of VNFs, a processor, or a memory.

In some embodiments, the deviation threshold value is a value defining a maximum allowed deviation under the minimum bound of usage of the at least one resource and a maximum allowed deviation over the maximum bound of usage of the at least one resource for the dimensioning interval.

In some embodiments, the provisioning (903) meets or maintains a quality of service, QoS, level for the telecommunications network.

In some embodiments, the machine learning model is one of a reinforcement learning model, a contextual bandit model, or a continuous optimization model.

In some embodiments, the machine learning model learns from at least the dimensioning (901).

Various operations from the flow charts of FIGS. 9 and 10 may be optional with respect to some embodiments of a method performed by a network node, and related methods. For example, operations of blocks 1001, 1003, and 1005 of FIG. 10 may be optional.

As used herein, network node refers to equipment capable, configured, arranged and/or operable to communicate with an underlying cloud infrastructure provider, and is able to provision/de-provision telecommunications cloud-resources (e.g., software applications running on VMs) as needed. The network node is can also be capable, configured, arranged and/or operable to communication directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNodeBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a network node having cloud-based functions (e.g., a virtual network node deployed in a cloud environment or a network node having functions (e.g., a management system) deployed in a cloud environment as described herein.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing

### DETAILED DESCRIPTION

### REFERENCES

WO2020095232A1, M. Toeroe, N. Nazarzadeoghaz, F. Khendek, “Dimensioning Network Services”
V. Podolskiy, A. Jindal, M. Gerndt, “laaS Reactive Autoscaling Performance Challenges”, CLOUD 2018
S. Schneider, N. Satheeschandran, M. Peuster, H. Karl, “Machine Learning for Dynamic Resource Allocation in Network Function Virtualization”, 978-1-7281-5684, IEEE (February 2020)
L. Toka, G. Dobreff, B. Fodor, B. Sonkoy, “Adaptive Al-based auto-scaling for Kubernetes”, CCGRID 2020
S. Horovitz, Y. Arian, “Efficient Cloud Auto-Scaling with SLA Objective using Q-Learning”, FiCloud 2018

1. A method performed by a network node for adaptive dimensioning and provisioning at least one resource of a cloud-based infrastructure of a telecommunications network, the method being orchestrator and cloud infrastructure agnostic, the method comprising:
dimensioning, to obtain a forecast of, a minimum bound of usage of the at least one resource and a maximum bound of usage of the at least one resource for a dimensioning interval based on an amount of data available, wherein the dimensioning interval is greater than a scaling interval of an underlying orchestrator;
provisioning of the at least one resource when the maximum bound of the dimensioning forecast exceeds current resources of the cloud-based infrastructure;
checking, on a periodic basis defined by the scaling interval of the underlying orchestrator, whether a measurement of actual usage of the at least one resource deviates from at least one of the minimum bound or the maximum bound by more than a deviation threshold value; and
performing a change to the value of the deviation threshold to a new value based on the checking.

2. The method of claim 1, wherein the change to the value is a decrease when the checking results in a deviation from at least one of the minimum bound or the maximum bound by more than the deviation threshold value, and further comprising:
performing a re-dimensioning and a re-provisioning of the at least one resource for a further dimensioning interval.

3. The method of claim 1, wherein the change to the value is an increase when the checking results in no deviation and the value of the deviation threshold is less than a pre-defined maximum bound.

4. The method of claim 1, wherein the change to the value is zero when the checking results in no deviation and the value of the deviation threshold equals a pre-defined maximum bound, and further comprising:
performing a re-dimensioning and a re-provisioning of the at least one resource for a further dimensioning interval when a time-duration of the dimensioning interval lapses without the occurrence of a deviation.

5. The method of claim 4, wherein the performing the re-dimensioning and the re-provisioning re-uses the dimensioning and the provisioning of the previous dimensioning interval.

6. The method of claim 1, further comprising:
controlling a frequency of the re-dimensioning and re-provisioning of the at least one resource for the further dimensioning interval based on the change to the value of the deviation threshold value.

7. The method of claim 1, wherein the performing a change comprises using a machine learning model for at least one of to change the deviation threshold value or to initiate a re-dimensioning followed by a re-provisioning, based on network traffic behavior, the network traffic behavior being the measurement of actual usage of the at least one resource that deviates by more than the deviation threshold value compared to the bounds of usage of the forecast obtained from the dimensioning.

8. The method of claim 6, wherein the controlling the frequency of the re-dimensioning and re-provisioning of the at least one resource for the further dimensioning interval based on the changing the value of the deviation threshold value comprises a reduction in the frequency when the value of the deviation threshold value increases, and an increase in the frequency when the value of the deviation threshold value decreases.

9. The method of claim 1, wherein the amount of data available is in a range from a minimum amount of data to a maximum amount of data.

10. The method of claim 9, wherein the minimum amount of data comprises a number of subscribers and network traffic metrics when deploying a specific service.

11. The method of claim 9, wherein the maximum amount of data comprises at least one of streaming data from the telecommunications network, historical data from the telecommunications network, features derived from historical data from the telecommunications network, and data on new services or new subscribers for the future for the telecommunications network.

12. The method of claim 1, wherein the at least one resource comprises at least one of a virtual network function (VNF), a unit of VNFs, a processor, or a memory.

13. The method of claim 1 wherein the deviation threshold value is a value defining a maximum allowed deviation under the minimum bound of usage of the at least one resource and a maximum allowed deviation over the maximum bound of usage of the at least one resource for the dimensioning interval.

14. The method of claim 1, wherein the provisioning meets or maintains a quality of service, QoS, level for the telecommunications network.

15. The method of claim 7 wherein the machine learning model is one of a reinforcement learning model, a contextual bandit model, or a continuous optimization model.

16. The method of claim 7, wherein the machine learning model learns from at least the dimensioning.

17. A network node, the network node comprising:
processing circuitry; and
memory coupled with the processing circuitry, wherein the memory includes instructions that when executed by the processing circuitry causes the network node to perform operations, the operations comprising:
dimension, to obtain a forecast of, a minimum bound of usage of the at least one resource and a maximum bound of usage of the at least one resource for a dimensioning interval based on an amount of data available, wherein the dimensioning interval is greater than a scaling interval of an underlying orchestrator;
provision the at least one resource when the maximum bound of the dimension forecast exceeds current resources of the cloud-based infrastructure;
check, on a periodic basis, defined by the scaling interval of the orchestrator, whether a measurement of actual usage of the at least one resource deviates from at least one of the minimum bound or the maximum bound by more than a deviation threshold value; and
perform a change to the value of the deviation threshold to a new value based on the check.

18. The network node of claim 17, wherein the change to the value is a decrease when the check results in a deviation from at least one of the minimum bound or the maximum bound by more than the deviation threshold value, and the memory includes instructions that when executed by the processing circuitry causes the network node to perform further operations comprising:
perform a re-dimensioning and a re-provisioning of the at least one resource for a further dimensioning interval.

19-24. (canceled)

25. The network node of claim 17, wherein the change to the value is an increase when the check results in no deviation and the value of the deviation threshold is less than a pre-defined maximum bound.

26. The network node of claim 17, wherein the change to the value is zero when the check results in no deviation and the value of the deviation threshold equals a pre-defined maximum bound, and the memory includes instructions that when executed by the processing circuitry causes the network node to perform further operations further comprising:
perform a re-dimensioning and a re-provisioning of the at least one resource for a further dimensioning interval when a time-duration of the dimensioning interval lapses without the occurrence of a deviation.
